(19) United States
(12) Patent Application Publication
(10) Pub. No.: US 2017/0309420 A1
(43) Pub. Date: Oct. 26, 2017

(54) BUTTON GUIDE STRUCTURE

(71) Applicant: CLARION CO., LTD., Saitama (JP)

(72) Inventor: Tooru IWAMOTO, Saitama (JP)

(73) Assignee: CLARION CO., LTD., Saitama (JP)

(21) Appl. No.: 15/526,403

(22) PCT Filed: Sep. 17, 2015
(86) PCT No.: PCT/JP2015/076408

§ 371 Date: May 12, 2017

(30) Foreign Application Priority Data
Nov. 21, 2014 (JP) 2014-236568

(51) Int. Cl. H01H 13/14

(52) U.S. Cl. CPC H01H 13/14; H01H 2221/058

(57) ABSTRACT

Provided is a button guide structure that makes it possible to achieve the reduction in cost and man-hour and the improvement in quality. In a button guide structure in which a push button 23 is provided on a front panel 11 through a guide unit in a slidable manner, the push button 23 operating a switch, the front panel 11 configuring a front surface of an electronic apparatus or the like, the front panel 11 includes a tubular portion 11b into which a part of the push button 23 is inserted, the push button 23 includes: a button main body portion 23a that is inserted into the tubular portion 11b; and an outer tubular portion 23b that is provided so as to surround the button main body portion 23a and that encloses the tubular portion 11b when the button main body portion 23a has been inserted into the tubular portion 11b, and the guide unit constituted by a rib 11k and a slit 23k is provided on an outer surface 11w of the tubular portion 11b and the outer tubular portion 23b.

### TECHNICAL FIELD

The present invention relates to a button guide structure of an in-vehicle apparatus or the like including a push button on a front panel whose front surface is coated.

### BACKGROUND ART

Conventionally, there is known a button guide structure to guide a push button that is used in the operation of an in-vehicle apparatus or the like, in a slidable manner (for example, see Patent Literature 1).

The above button guide structure is constituted by a guide groove portion provided on the main body side of the apparatus and a guide rib provided on the push button, and the guide rib engages with the guide groove portion in a slidable manner.

### CITATION LIST

### Patent Literature

Patent Literature 1: Japanese Patent Laid-Open No. 2013-137972

### SUMMARY OF INVENTION

### Technical Problem

In Patent Literature 1, for example, in the case where the surface of a front panel is coated by spraying coating material while the guide groove portion is provided on the front panel side of the main body of the apparatus, if the coating material is sprayed to the guide groove portion through an opening of the front panel and adheres to the guide groove portion, the adhered coating material sometimes exerts influence on the operation feeling for the push button, when the push button is incorporated in the main body of the apparatus after the coating is completed. For preventing this, the masking of the guide groove portion is necessary, leading to the increase in the cost for preparing a masking jig and the man-hour for performing the masking. Furthermore, even when the masking is performed, the coating material sometimes flows around to the guide groove portion, from small gaps, and the coating quality is likely to vary.

An object of the present invention is to provide a button guide structure that makes it possible to achieve the reduction in cost and man-hour and the improvement in quality.

### Solution to Problem

The present description includes all contents of Japanese Patent Application No. 2014-236568 filed on Nov. 21, 2014.

For solving the above-described problem, an aspect of the present invention is a button guide structure in which a push button is provided on a front panel through a guide unit in a slidable manner, the push button operating a switch, the front panel configuring a front surface of an electronic apparatus or the like, in which the front panel includes a tubular portion into which a part of the push button is inserted, the push button includes: a button main body portion that is inserted into the tubular portion; and an outer tubular portion that is provided so as to surround the button main body portion and that encloses the tubular portion when the button main body portion has been inserted into the tubular portion, and the guide unit is provided on an outer surface of the tubular portion and the outer tubular portion.

According to this configuration, when the front panel is coated, the coating material does not adhere to the guide unit provided on the outer surface side of the tubular portion. Therefore, unlike the related art, the masking of the guide unit for the coating is unnecessary, and it is possible to reduce the cost for the masking jig and the man-hour for the masking. Further, the variation in coating quality, which is generated in the case where the masking is performed, is not generated. It is possible to achieve the reduction in cost and man-hour and the improvement in quality.

In the above configuration, the guide unit may include: a rib that is provided on the outer surface of the tubular portion so as to extend in a slide direction of the push button; and a rib engagement portion that is provided on the outer tubular portion so as to engage with the rib in a slippable manner. According to this configuration, it is possible to adopt a simple structure in which the rib and the rib engagement portion are engaged in a slippable manner, and to reduce the cost.

Further, in the above configuration, the rib engagement portion may be a slit or a groove. According to this configuration, it is possible to easily form the slit or the groove, and to reduce the cost.

Further, in the above configuration, the rib may restrict a slide position of the push button, together with the rib engagement portion. According to this configuration, it is possible to configure a positioning portion for the push button by the rib and rib engagement portion that guide the push button, to achieve the simplification of the shapes of the front panel and the push button and the decrease in parts count, compared to the case where a positioning portion is separately provided, and to reduce the cost.

Further, in the above configuration, a retaining unit may restrict the slide position of the push button, the retaining unit preventing the push button from coming off from the tubular portion. According to this configuration, the retaining unit of the push button can serve also as a slide position restriction member, and it is possible to decrease the number of parts and to reduce the cost.

### Advantageous Effects of Invention

The front panel in the aspect of the present invention includes the tubular portion into which a part of the button is inserted, the push button includes the button main body portion that is inserted into the tubular portion, and the outer tubular portion that is provided so as to surround the button main body portion and that encloses the tubular portion when the button main body portion has been inserted into the tubular portion, and the guide unit is provided on the outer surface of the tubular portion and the outer tubular portion. Accordingly, when the front panel is coated, the coating material does not adhere to the guide unit provided on the outer surface side of the tubular portion. Therefore, unlike the related art, the masking of the guide unit for the coating is unnecessary, and it is possible to reduce the cost for the masking jig and the man-hour for the masking. Further, the variation in coating quality, which is generated in the case where the masking is performed, is not generated. It is possible to achieve the reduction in cost and man-hour and the improvement in quality.

### BRIEF DESCRIPTION OF DRAWINGS

FIG. 1 is a perspective view of an in-vehicle device that employs a push-button guide structure in an embodiment of the present invention.

FIG. 2 is a perspective view showing a front panel and a push button attached to the front panel, as viewed diagonally from the front side.

FIG. 3 is a perspective view showing the front panel and the push button detached from the front panel, as viewed diagonally from the front side.

FIG. 4 is a perspective view showing the front panel and the push button attached to the front panel, as viewed diagonally from the rear side.

FIG. 5 is a perspective view showing the front panel and the push button detached from the front panel, as viewed diagonally from the rear side.

FIGS. 6A and 6B are plan views showing the front panel and the push button, in which FIG. 6A is a plan view showing a front wall and a tubular portion of the front panel and FIG. 6B is a plan view showing the push button.

FIGS. 7A and 7B are plan views showing fitted states of the tubular portion of the front panel and the push button, in which FIG. 7A is a plan view showing a state before the push button is pushed and FIG. 7B is a plan view showing a state after the push button is pushed.

FIG. 8 is a cross-sectional view taken from line VIII-VIII in FIG. 2.

### DESCRIPTION OF EMBODIMENT

Hereinafter, an embodiment of the present invention will be described with reference to the drawings. Here, in each drawing, the near side (front side) of an in-vehicle device 10 is indicated by an arrow FR.

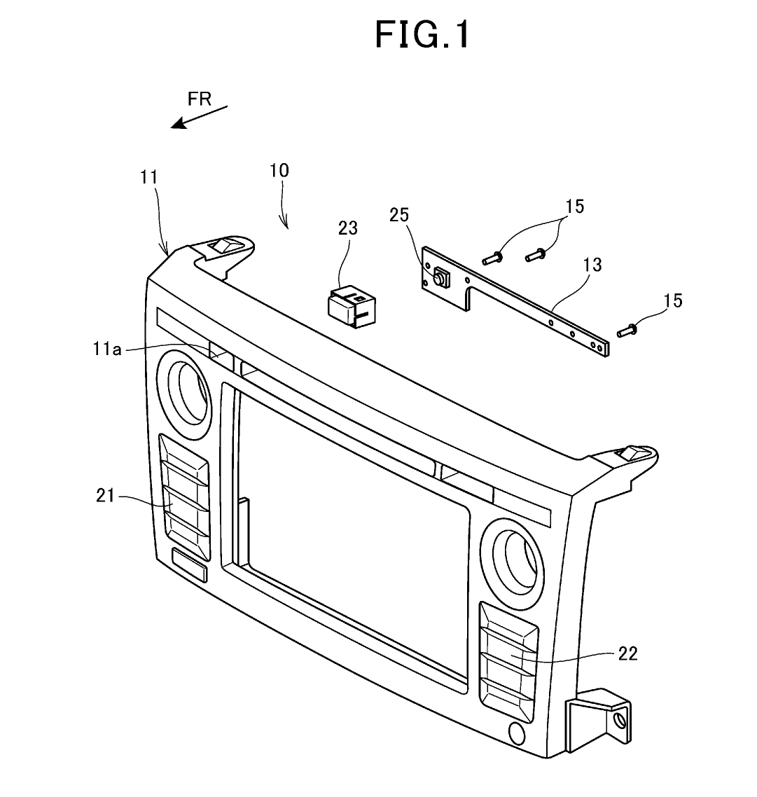

FIG. 1 is a perspective view of the in-vehicle device 10 that employs a push-button guide structure in an embodiment of the present invention.

The in-vehicle device 10 includes a plastic front panel 11 that configures a front surface thereof, and a circuit board 13 that is attached to a rear portion of the front panel 11. Here, reference numeral 15 denotes a screw for attaching the circuit board 13 to the front panel 11.

The in-vehicle device 10 is an in-vehicle electronic apparatus such as an audio device that plays a CD, a DVD or the like, and a navigation device that searches a route to a designated destination, or the like, and is mounted so as to be embedded in a storage space provided on an instrument panel or the like of a vehicle.

On the front panel 11, a plurality of plastic push buttons 21, 22, 23 are provided as operation units. For example, one push button 23 is inserted into an opening 11a provided at an upper portion of the front panel 11, from the rear side, and is retained so as not to come off from the opening 11a. Furthermore, a switch 25 provided on the circuit board 13 abuts on a rear end portion of the push button 23. Accordingly, when the push button 23 is pushed from the near side of the in-vehicle device 10 to the far side, a moving contact of the switch 25 comes in contact with a fixed contact, and the switch 25 is turned on. As a result, a predetermined circuit provided on the circuit board 13 becomes a closed state so that electricity flows, resulting in the execution of a predetermined function.

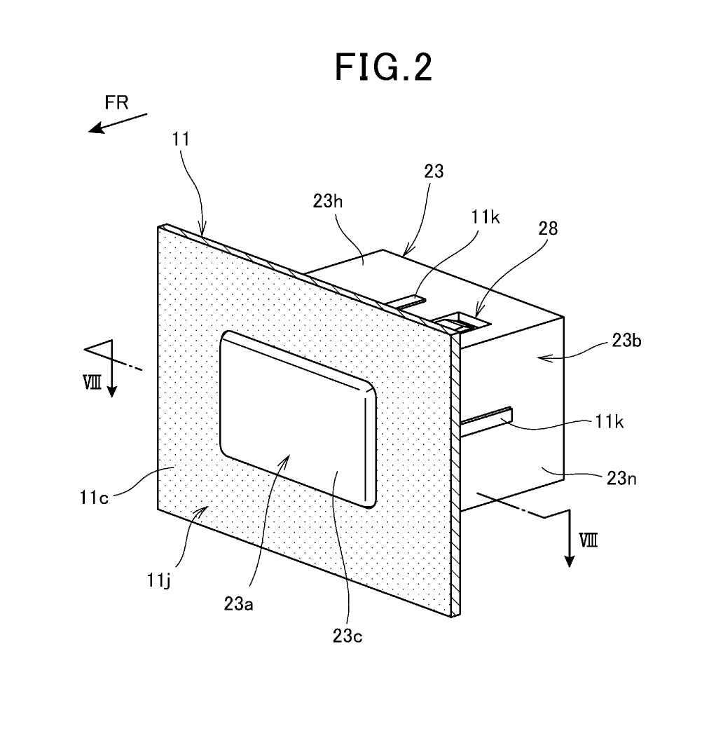

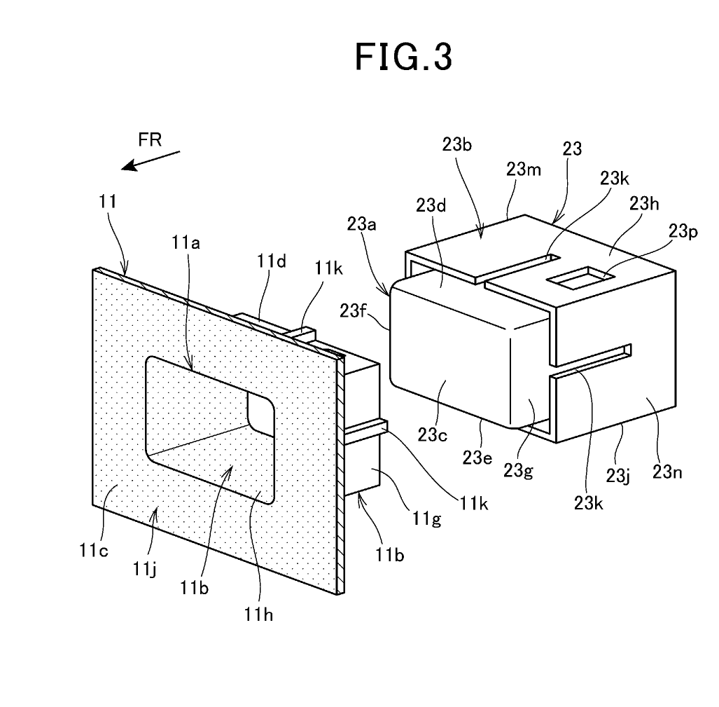

FIG. 2 is a perspective view showing the front panel 11 and the push button 23 attached to the front panel 11, as viewed diagonally from the front side. FIG. 3 is a perspective view showing the front panel 11 and the push button 23 detached from the front panel 11, as viewed diagonally from the front side.

As shown in FIG. 2 and FIG. 3, the front panel 11 includes a front wall 11j having a nearly flat plate shape, the opening 11a opened on the front wall 11j, and a tubular portion 11b having a rectangular cross-section and extending rearward from an edge portion of the opening 11a nearly perpendicularly, and a part of the push button 23 is inserted into the tubular portion 11b from the rear side.

To a surface 11c on the front side of the front wall 11j, spray coating is performed for coloration, decoration and the like. A plurality of dots in the figure show a coated surface obtained by the spray coating to the surface 11c. The coating material sprayed by the spray coating adheres not only to the surface 11c but also to an inner surface 11h of the tubular portion 11b, and forms a coated surface. Here, on the push button 23, the coating is not performed at least to a portion that slips on the tubular portion 11b and the like.

The push button 23 includes a button main body portion 23a that is inserted into the tubular portion 11b, and a box-shaped outer tubular portion 23b that surrounds the button main body portion 23a.

The button main body portion 23a includes a front wall 23c that is pushed by a finger or the like, and an upper wall 23d, a lower wall 23e and lateral walls 23f, 23g that extend from an upper edge, a lower edge and lateral edges of the front wall 23c, respectively.

The outer tubular portion 23b is a portion that encloses the tubular portion 11b when the button main body portion 23a has been inserted into the tubular portion 11b, and includes an upper wall 23h, a lower wall 23j and lateral walls 23m, 23n that are provides so as to face the upper wall 23d, lower wall 23e and lateral walls 23f, 23g of the button main body portion 23a, respectively. On the upper wall 23h, the lower wall 23j and the lateral walls 23m, 23n, slits 23k that extend rearward from the respective front edge portions are formed.

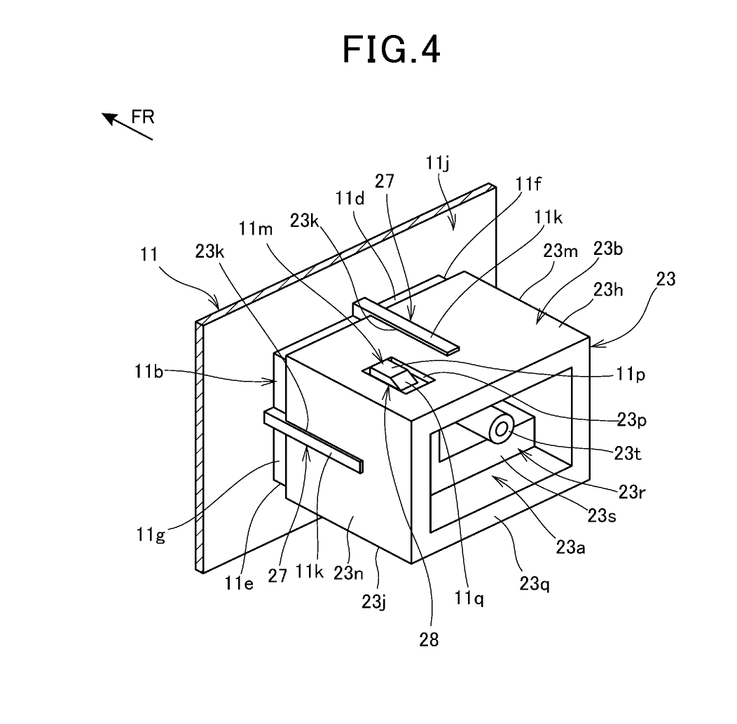

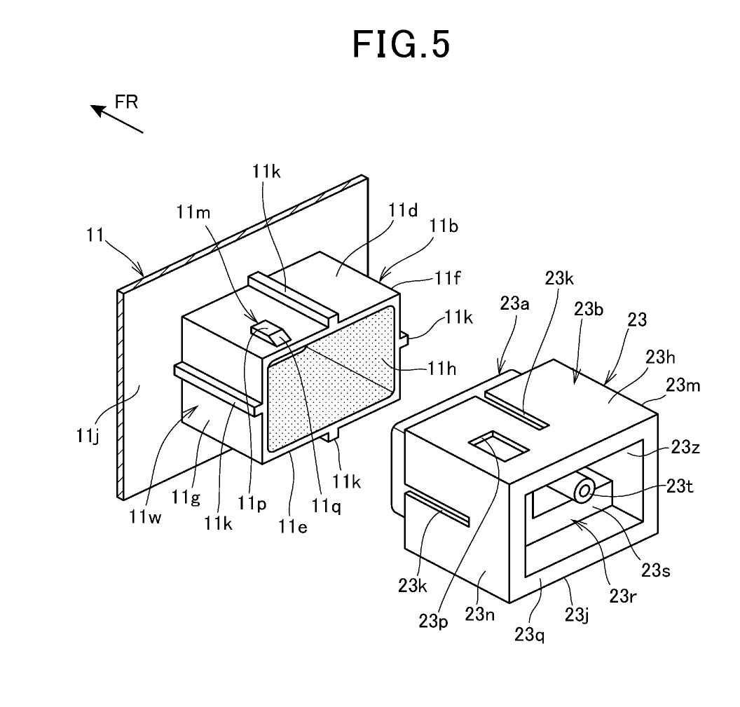

FIG. 4 is a perspective view showing the front panel 11 and the push button 23 attached to the front panel 11, as viewed diagonally from the rear side. FIG. 5 is a perspective view showing the front panel 11 and the push button 23 detached from the front panel 11, as viewed diagonally from the rear side.

As shown in FIG. 4 and FIG. 5, the tubular portion 11b of the front panel 11 is constituted by an upper wall 11d, a lower wall 11e and lateral walls 11f, 11g that integrally extend rearward from the front wall 11j, and ribs 11k that extend from the front wall 11j nearly perpendicularly, that is, extend in the front-rear direction are integrally formed on outer surfaces 11w of the upper wall 11d, the lower wall 11e and the lateral walls 11f, 11g. The ribs 11k and the slits 23k are engaged in a slippable manner, and the plurality of (four) ribs 11k and the plurality of (four) slits 23k constitute guide units 27.

On the upper wall 11d, a stopper convex portion 11m that projects upward from the outer surface 11w is formed at one side of the rib 11k. The stopper convex portion 11m includes, on the upper surface, a flat surface 11p provided at a front side, and an inclined surface 11q formed at a rear portion in a rear downward direction.

On the upper wall 23h of the push button 23, a stopper hole portion 23p that engages with the stopper convex portion 11m of the tubular portion 11b is formed at one side of the slit 23k. The stopper convex portion 11m and the stopper hole portion 23p constitute a retaining unit 28 that allows the push button 23 not to come off from the tubular portion 11b. The front ends of the stopper convex portion 11m and the stopper hole portion 23p abut on each other in the front-rear direction, and thereby, the push button 23 is avoided from coming off from the tubular portion 11b. The inclined surface 11q of the stopper convex portion 11m is a portion for easily moving the stopper convex portion 11m to the inside of the outer tubular portion 23b, which has flexibility, and smoothly engaging the stopper convex portion 11m and the stopper hole portion 23p when the push button 23 is attached to the tubular portion 11b.

The button main body portion 23a and outer tubular portion 23b of the push button 23 are integrally connected by a frame-shaped connection wall 23q provided at the rear end.

A thick portion 23r that has a sideways U-shape as viewed from the back side is integrally provided on an inner surface 23z of the button main body portion 23a, and a switch abutting portion 23t that projects rearward is integrally molded on a back surface 23s of the thick portion 23r. The switch abutting portion 23t is a portion that pushes the moving contact of the switch 25 (see FIG. 1), and when the push button 23 is pushed, the switch 25 is turned on by the switch abutting portion 23t.

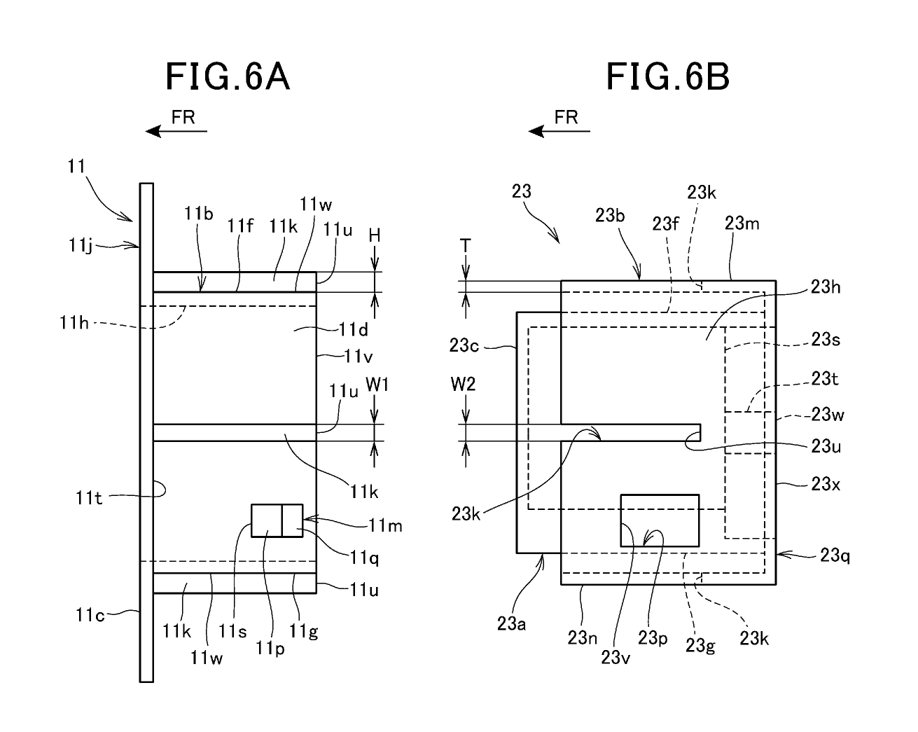

FIGS. 6A and 6B are plan views showing the front panel 11 and the push button 23. FIG. 6A is a plan view showing the front wall 11j and tubular portion 11b of the front panel 11, and FIG. 6B is a plan view showing the push button 23.

As shown in FIGS. 6A and 6B, the ribs 11k on the upper wall 11d and lower wall 11e (see FIG. 5) of the front panel 11 are arranged at a central portion in the horizontal width (the width in the vertical direction in the figure) of the tubular portion 11b, and the ribs 11k on the lateral walls 11f, 11g are arranged at a central portion in the vertical width of the tubular portion 11b (see FIG. 5).

The front end of the rib 11k is integrally connected with a back surface lit of the front wall 11j, and a rear end surface 11u of the rib 11k is positioned on the same plane as a rear end surface 11v of the tubular portion 11b.

Further, the width W2 of the slit 23k is formed so as to be larger than the width W1 of the rib 11k, such that the rib 11k smoothly slides in the slit 23k. The wall thickness T of the outer tubular portion 23b (the wall thickness of the upper wall 23h, the lower wall 23j (see FIG. 5) and the lateral walls 23m, 23n ) is formed so as to be smaller than the height H of the rib 11k from the outer surface 11w of the tubular portion 11b.

A rear end surface 23w of the switch abutting portion 23t is positioned on the same plane as a back surface 23x of the connection wall 23q. The stopper convex portion 11m and the stopper hole portion 23p are formed such that the respective contours are rectangular shapes.

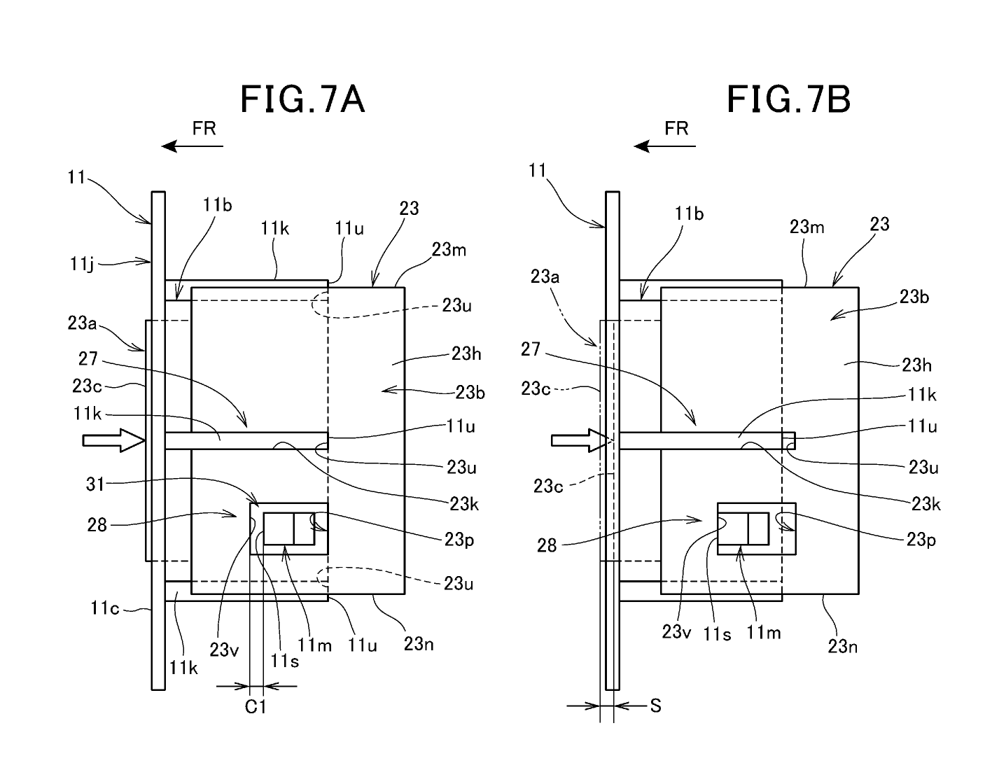

FIGS. 7A and 7B are plan views showing fitted states of the tubular portion 11b of the front panel 11 and the push button 23. FIG. 7A is a plan view showing a state before the push button 23 is pushed, and FIG. 7B is a plan view a state after the push button 23 is pushed.

As shown in FIG. 7A, a rear end surface 23u of the slit 23k of the push button 23 abuts on the rear end surface 11u of the rib 11k of the tubular portion 11b, and the positioning is performed such that the push button 23 is at the most forward position in the slide direction. The push button 23 is energized forward by the elastic force of the moving contact of the switch 25 (see FIG. 1), and as a result, the rear end surface 23u of the slit 23k is pressed on the rear end surface 11u of the rib 11k.

Further, a gap 31 with a clearance C1 is formed between a front end surface 11s of the stopper convex portion 11m of the tubular portion 11b and a front end surface 23v of the stopper hole portion 23p of the push button 23.

As shown in FIGS. 7A and 7B, when the push button 23 is pushed in the direction of the outline arrow, the push button 23 slides rearward. Then, the front end surface 23v of the stopper hole portion 23p of the push button 23 abuts on the front end surface 11s of the stopper convex portion 11m, and the positioning is performed such that the push button 23 is at the most rearward position in the slide direction. At this time, the total slide amount of the push button 23 is S.

In this way, the slide-directional rearward movement of the push button 23 is restricted by the stopper convex portion 11m and stopper hole portion 23p that have a retaining function.

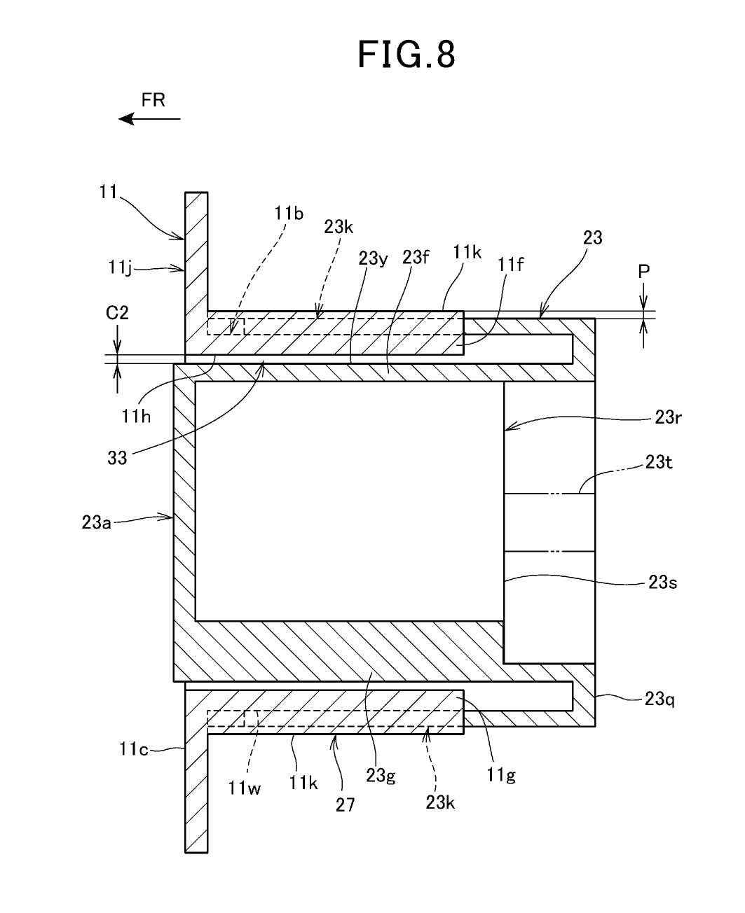

FIG. 8 is a cross-sectional view taken from line VIII-VIII in FIG. 2.

An inner surface 24a of the outer tubular portion 23b of the push button 23 is fitted to the outer surface 11w of the tubular portion 11b of the front panel 11, in a slippable manner. Further, a gap 33 with a clearance C2 is provided between the inner surface 11h of the tubular portion 11b of the front panel 11 and an outer surface 23y of the button main body portion 23a of the push button 23. In the tubular portion 11b and the button main body portion 23a, the gap 33 is provided between the upper walls 11d, 23d (see FIG. 3 and FIG. 5), between the lower walls 11e, 23e (see FIG. 3 and FIG. 5), between the lateral walls 11f, 23f, and between the lateral walls 11g, 23g.

Since the inner surface 24a of the outer tubular portion 23b is fitted to the outer surface 11w of the tubular portion 11b in a slippable manner and the gap 33 is provided between the inner surface 11h of the tubular portion 11b and the outer surface 23y of the button main body portion 23a in this way, it is possible to perform the slippage between the outer surface 11w of the tubular portion 11b and the inner surface 24a of the outer tubular portion 23b, which are not coated, to prevent the slippage between the coatings that are provided on the inner surface 11h of the tubular portion 11b and the outer surface 23y of the button main body portion 23a respectively, to enhance the operation feeling for the push button 23, and to avoid damages caused by the slippage.

Further, the rib 11k projects from the outer tubular portion 23b of the push button 23 by a projection amount P. As a result, the area of the slippage between the rib 11k and the slit 23k is maximized, and it is possible to suppress the abrasion caused by the slippage between the rib 11k and the slit 23k, for a long time, and to further increase the rigidity of the tubular portion 11b.

As shown in the above FIG. 1 and FIGS. 3 to 5, in the button guide structure in which the push button 23 for operating the switch 25 is provided on the front panel 11 configuring the front surface of an electronic apparatus or the like through the guide unit 27 in a slidable manner, the front panel 11 includes the tubular portion 11b into which a part of the push button 23 is inserted, the push button 23 includes a button main body portion 23a that is inserted into the tubular portion 11b, and the outer tubular portion 23b that is provided so as to surround the button main body portion 23a and that encloses the tubular portion 11b when the button main body portion 23a has been inserted into the tubular portion 11b, and the guide unit 27 is provided on the outer surface 11w of the tubular portion 11b and the outer tubular portion 23b.

According to this configuration, when the front panel 11 is coated, the coating material does not adhere to the guide unit 27 provided on the outer surface 11w side of the tubular portion 11b. Therefore, unlike the related art, the masking of the guide unit for the coating is unnecessary, and it is possible to reduce the cost for the masking jig and the man-hour for the masking. Further, the variation in coating quality, which is generated in the case where the masking is performed, is not generated. It is possible to achieve the reduction in cost and man-hour and the improvement in quality.

Further, as shown in FIG. 5, the guide unit 27 includes the rib 11k that is provided on the outer surface 11w of the tubular portion 11b so as to extend in the slide direction of the push button 23, and the slit 23k as the rib engagement unit that is provided on the outer tubular portion 23b so as to engage with the rib 11k in a slippable manner. Therefore, it is possible to adopt a simple structure in which the rib 11k and the slit 23k are engaged in a slippable manner, and to reduce the cost.

Further, since the rib engagement portion is the slit 23k, it is possible to easily form the slit 23k, and to reduce the cost.

Further, as shown in FIGS. 7A, 7B, the rib 11k restricts the slide position of the push button 23, together with the rib 11k. Therefore, it is possible to configure a positioning portion for the push button 23 by the rib 11k and slit 23k that guide the push button 23, to achieve the simplification of the shapes of the front panel 11 and the push button 23 and the decrease in parts count, compared to the case where a positioning portion is separately provided, and to reduce the cost.

Further, the retaining unit 28 for preventing the push button 23 from coming off from the tubular portion 11b restricts the slide position of the push button 23. Therefore, the retaining unit 28 of the push button 23 can serve also as a slide position restriction member, and it is possible to decrease the number of parts and to reduce the cost.

The above-described embodiment shows just one mode of the present invention, and modifications and applications can be arbitrarily made without departing from the spirit of the present invention.

For example, in the above embodiment, as shown in FIG. 5, the slit 23k is provided as the rib engagement portion that is provided on the outer tubular portion 23b so as to engage with the rib 11k in a slippable manner, but without being limited to this, as the rib engagement portion, a groove (concave portion) that engages with the rib of the tubular portion of the front panel in a slippable manner may be provided on the inner surface of the outer tubular portion of the push button.

Further, a concave-shaped portion that extends in the slide direction of the push button may be provided on the outer surface of the tubular portion of the front panel, and a convex-shaped portion that engages with the above concave-shaped portion in a slidable manner may be provided on the inner surface of the outer tubular portion of the push button.

### REFERENCE SIGNS LIST

11 front panel
11b tubular portion
11k rib
11w outer surface of tubular portion
21, 22, 23 push button
23a button main body portion
23b outer tubular portion
23k slit (rib engagement portion)
25 switch
27 guide unit
28 retaining unit

1. A button guide structure in which a push button is provided on a front panel through a guide unit in a slidable manner, the push button operating a switch, the front panel configuring a front surface of an electronic apparatus or the like, wherein
the front panel comprises a tubular portion into which a part of the push button is inserted,
the push button comprises: a button main body portion that is inserted into the tubular portion; and an outer tubular portion that is provided so as to surround the button main body portion and that encloses the tubular portion when the button main body portion has been inserted into the tubular portion, and
the guide unit is provided on an outer surface of the tubular portion and the outer tubular portion.

2. The button guide structure according to claim 1, wherein the guide unit comprises: a rib that is provided on the outer surface of the tubular portion so as to extend in a slide direction of the push button; and a rib engagement portion that is provided on the outer tubular portion so as to engage with the rib in a slippable manner.

3. The button guide structure according to claim 2, wherein the rib engagement portion is a slit or a groove.

4. The button guide structure according to claim 2, wherein the rib restricts a slide position of the push button, together with the rib engagement portion.

5. The button guide structure according to claim 4, wherein a retaining unit restricts the slide position of the push button, the retaining unit preventing the push button from coming off from the tubular portion.
